(19) United States
(12) Patent Application Publication
(10) Pub. No.: US 2012/0271638 A1
(43) Pub. Date: Oct. 25, 2012

(54) INTERACTIVE TOYS AND A METHOD OF SYNCHRONIZING OPERATION THEREOF

(75) Inventor: Jason Regler, Westbury (GB)

(73) Assignee: RB CONCEPTS Ltd., Devon (GB)

(21) Appl. No.: 13/500,412

(22) PCT Filed: Oct. 5, 2010
(86) PCT No.: PCT/GB2010/051663

§ 371 Date: Jul. 12, 2012

(30) Foreign Application Priority Data
Oct. 5, 2009 (GB) 0917403.8

(51) Int. Cl. G10L 21/00

(52) U.S. Cl. 704/272; 704/E21.001

(57) ABSTRACT

Individual audio tracks (20-24) for interactive reproduction at a remote toy (104) are each encoded with a sub-audible tone (12-18) or code that uniquely identifies the track with audible output and/or functional operation of the toy (104). Detection of the sub-audible tone at the interactive toy opens the audio path and permits related motor control in the toy, whereas absence of a relevant sub-audible tone disables at least the audio and, preferably, both the toy's speaker (122) and at least one controllable motor (130, 132). The sub-audible tone (12-18) or code is inserted for the duration of activity only and may come into and out of existence as a specific character track (amongst the plurality of individual audio tracks) moves between active and inactive phases. The audio tracks for remote transmission at the toys (104) are assigned to only a first channel of a stereo audio circuit, with a second channel of the stereo circuit assigned to support a context or background track that is produced from speakers (51) of a media player (54) physically separate from the remote toys (104). Conventional synchronized transmission of both stereo channels provides a basis for interaction, with synchronicity between the media player (54) and the remote toy (104) maintained by the sub-audible tones (12-18). For simultaneous audio activity in multiple toys, a different sub-audible tone is used relative to individual tones or codes used to control audio output and operation of those multiple toys.

### FIELD OF THE INVENTION

This invention relates, in general, to interactive toys and components in an interactive toy system and is particularly, but not exclusively, applicable to toy dolls or educational learning aids that synchronize their speech and movement with multi-media content from an entertainment source, such as a television programme or video played on a computer or the like. The invention further relates to a method of synchronizing operation of interactive toys.

### SUMMARY OF THE PRIOR ART

It has been recognised that the learning process is often made easier when effective interactions arise between the learning source and the student. Indeed, it seems that there is an increased susceptibility to uptake of knowledge in situations which are perceived by the student to be fun, since the level of concentration is often higher and distraction less likely. And, in any event, interaction between several motorised toys (such as soft toys or mannequins) brings about a certain amount of intrigue and curiosity in young children.

Interactive audio-visual entertainment systems have been proposed where a remote device, such as a doll or plush toy, interacts with audio and/or visual content reproduced on a listening or viewing platform. For example, U.S. Pat. No. 5,636,994 describes an interactive system which includes a computer having a video output display and a pair of audio output channels. A program source, such as a CD-ROM, contains information which is processed by the computer to provide a visual presentation on the display and audio signals in the audio output channels. At least one input device is connected to the computer for controlling the manner in which the program information is processed and the audio signals are delivered to the audio output channels. One speaker is connected to the computer for reproducing sounds represented by the audio signals in one of the audio output channels, and the audio signals in the other channel are applied to at least one transducer in an animated doll. Transducers in the doll include a speaker for reproducing sounds to be made by the doll and actuators for moving parts of the doll, such as the mouth and eyes in accordance with those sounds. However, the system is unable to deal with selective switching of audio output. Control of the audio output from and movement of the doll is therefore actioned by a child through keystroke entry and mouse control at the interconnected computer.

In U.S. Pat. No. 5,636,994, multiple channels are made available to multiple dolls through the use of channel separation in the frequency domain. More particularly, a signal splitter at the computer effects channel separation by causing a frequency shift in one channel towards an upper end of the audio spectrum, i.e. 0-5 kHz frequency signals are translated or shifted to a frequency between 15 kHz and 20 kHz. At the receiver in the doll, selective high-pass or low pass filtering is then employed to separate out distinct channels for particular dolls, with a frequency down-shift applied (as appropriate) to recover the original audio for output by one of multiple dolls. Transmissions in the high frequency range can, however, be irritating if detected. Also, there is a cost associated with the splitting and frequency translation functions proximate to the computer and also the complementary processing at the receiver/doll that permits the multiplexing and de-multiplexing of essentially discrete signals.

WO 2007/029247 describes an audio switching system where the audio signal on one of the channels is re-directed to a transmitter for transmission to a remote device doll upon detection of an embedded actuation signal added to the audio channel for signalling the switching between modes. When switching occurs, the audio signal on the other channel is split to provide split mono-audio on both audio outputs. The arrangement requires a signal processor to be associated with at least one of the audio inputs and, consequently, provides a more complicated system that that of U.S. Pat. No. 5,636,994 discussed above.

FR 2834913 describes another interactive toy system. A toy, containing a permanent magnet, effects closure of a control circuit located in a base unit. Closure of the circuit therefore permits audio output from speakers connected to the base unit. Signals are initially provided to the base unit from an interconnected computer. A central base unit may act as a node to which additional secondary base units are connected. The central or main base comprises a processor that selects and shunts audio signals towards the secondary bases.

While these prior art interactive systems provide remote transmissions from a centralised computer to a doll, such as a cuddly bear (or the like), these systems are limited to the extent that the number of interactive elements (and the synchronization thereof) is seemingly restricted either by a limited bandwidth and/or delays associated with step-wise processing at nodes/distribution points through the system.

### SUMMARY OF THE INVENTION

According to a first aspect of the invention there is provided a method of supporting an interactive audio experience between a media player and a plurality of remotely located toys, the method comprising: assigning a context audio track to a first channel to an audio system having two channels; generating a composite audio signal from a plurality of audio tracks, each audio track associated with a specific one of the plurality of toys, the composite audio signal assigned to a second, different channel of the audio system; assigning and embedding a unique activation code into each track, the activation code present for substantially an entire duration of activity of each speech segment on each track; broadcasting the composite audio signal; and at each of the plurality of toys, detecting the presence of any affiliated activation code within the broadcast signal and opening an audio gate and audio output for the duration of the detection of the affiliated activation code.

In another aspect of the present invention there is provided an interactive toy comprising: a receiver chain configured to receive a composite audio signal containing multiple audio tracks associated with the operation of multiple different toys, the receiver chain arranged to separate an audio output from embedded activation codes associated with the audio output; a controller arranged or configured: to detect the presence of a pre-assigned activation code affiliated to the toy; and to open an audio gate for the duration of detection of the pre-assigned activation code, whereby the audio output is reproduced from the toy.

In a further aspect of the present invention there is provided a media player including a transmitter, the media player configured to: assign a context audio track to a first channel of an audio system having two channels; generate a composite audio signal from a plurality of audio tracks, each audio track associated with a specific one of the plurality of toys, the composite audio signal assigned to a second, different channel of the audio system; assign and embed a unique activation code into each track, the activation code present for substantially an entire duration of activity of each speech segment on each track; and wherein the transmitter is arranged to modulate and broadcast the composite audio signal such that time synchronization exists between the first and second channels of the audio system and time synchronization exists between the context audio track presented by the media player and the audio presented at each of the plurality of interactive toys by virtue of the embedded activation codes.

Advantageously, the present invention an interactive toy or mannequin system that is highly synchronized. Furthermore, use of embedded activation codes (such as CTCSS tones) results in a toy that can only become active upon receipt of legitimate media content relevant to the toy; this prevents tampering with the toy, e.g. getting the toy to say undesired dialogue, etc). Controlled embedding of activation codes can also effect regulation of media content by restricting production of third party content.

Beneficially, since the toy's speaker is only switched on when it is receiving tones/dialogue, this greatly reduces the risk of interference. The various embodiments can, furthermore, be produced in a cost-effective manner using relatively inexpensive PIC technologies. And the use of the activation codes produces a stereo effect, notwithstanding that the audio tracks are consolidated onto a single audio channel, e.g. the left channel of a stereo system.

### BRIEF DESCRIPTION OF THE DRAWINGS

Exemplary embodiments of the present invention will now be described with reference to the accompanying drawings, in which:

FIG. 1 is a waveform diagram that reflects a sub-audible tone encoding process according to a preferred embodiment of the present invention;

FIG. 2 is a waveform diagram showing relative timing between a broadcast composite signal envelope and a related media platform speaker output obtained from the sub-audible tone encoding process of FIG. 1;

FIG. 3 is a schematic representation of a preferred arrangement for an interactive media suite, including an output chain;

FIG. 4 is a schematic representation of a preferred receiver assembly in a toy, the receiver assembly permitting selective recovery of output data from the composite signal envelope of FIG. 2 and interactive engagement with the media suite of FIG. 3;

FIG. 5 is a flow diagram of the process for encoding and recovering interactive media according to a preferred embodiment of the present invention.

### DETAILED DESCRIPTION OF A PREFERRED EMBODIMENT

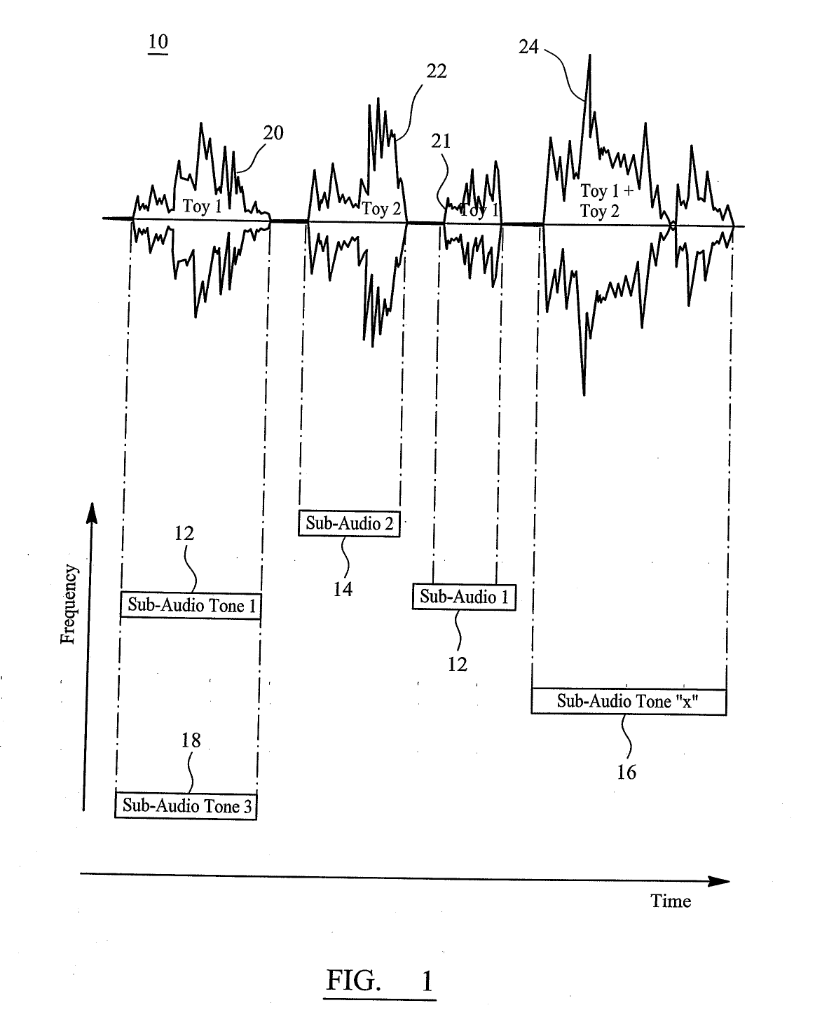

Turning to FIG. 1, a waveform diagram 10 illustrates how (in accordance with a preferred embodiment of the present invention) sub-audible tones 12-18 are encoded relative to time disparate audio segments 20-24 designated for one or more toys. For a specific toy, a succession (but not necessarily a contiguous succession) of audio segments (such as speech envelopes 20 and 21) constitute an audio track for that particular toy. Therefore, the audio track may contain pauses where the toy is silent. In a preferred embodiment of the invention, each audio segment for each toy is assigned a common identifying code in the form of a CTCSS signal which is presently for the entire duration of the speech envelope. The CTCSS signal therefore rises at substantially the beginning of the speech envelope and then ceases at substantially the end of the specific speech envelope.

Therefore, a first toy (“Toy 1) will have a first sub-audible tone 12, whereas a second toy will have a second, but different sub-audible tone 14. At points in time when the audio segment is itself a composition of multiple audio outputs from multiple toys, another different sub-audible tone 16 (“sub-audible tone x”) is applied to all associated toys. It is also contemplated that a particular toy may have a further ancillary control tone 18 (such as sub-audible tone 3) applied within its speech envelope, which ancillary tone 18 may be for a duration less than or equal to the duration of the speech envelope 20. In fact, the ancillary tone 18 may punctuate the primary tone or code multiple times during a single speech envelope (for reason that will become apparent), or the ancillary tone can replace the primary tone during speech envelope to produce a secondary effect (such as head movement) in a bear that is already interactively singing by virtue of the existence of the primary sub-audible tone.

The sub-audible tones (or codes, as the case may be) are therefore taken from a tone/code library that cross-references the toy to the tone/code. The sub-audible tones 12-18 therefore act to control and synchronize operation of an interactive toy located remotely from a central media player, such as a computer.

CTCSS is an acronym for “Continuous Tone Coded Squelch System”. CTCSS is a sub audible tone in the range of 67 Hz to 254 Hz. Conventionally, any one or more of about fifty tones (sometimes referred to as “sub-channels”) can be used to gain access to a repeater in a two-way radiotelephone system. Each CTCSS is therefore essentially a sine wave having a specific frequency.

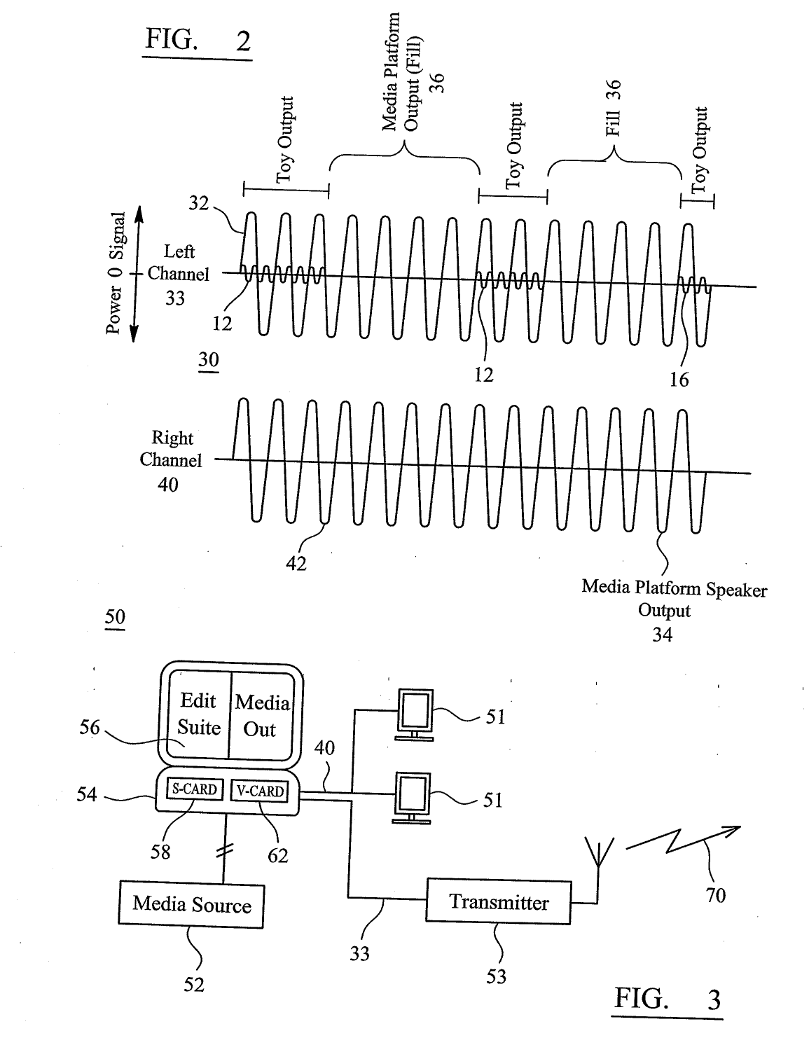

To appreciate further the nature of the present invention, reference is made to FIG. 2 which is a waveform diagram 30 showing relative timing between a broadcast composite signal envelope 32 and a related speaker output 34 from a central media platform. For ease of reproduction only, the audio channel is shown as a simple undulating wave, rather than the underlying and more complex amplitude-varying form shown in FIG. 1.

In FIG. 2, audio for remote generation at a remote speaker at a remote toy is consolidated (mixed down) into a composite signal envelope 32 that is assigned for transmission on the left channel 33 of a stereo audio circuit. Each speech envelope (e.g. reference numeral 20 of FIG. 1) has been mixed with its assigned control tone 12 or code; this is represented by the overlaying of the small amplitude control tone and the instantaneous audio output. The control tone or code preferably has a relatively low power level compared to the magnitude of the speech components in the speech envelope 20-24; this reduces the likelihood of introducing distortion, such as harmonics, into any audio signal recovered from the composite signal envelope 32 for output.

To provide an effective reference in time for delivery of the audio signal from each toy, some form of “fill” or buffering 36 is included, if necessary, to time separate adjacent audio outputs from one or more remote toys. For example, time buffering 36 can take the form of background media channel output earmarked for reproduction on a media player speaker remote from the interactive toy.

If audio output from different toys is exactly contiguous, then time buffering 36 may not be required for a certain portion of a scene. In this case, the unique tones or codes provide a context for synchronized output for the various toys.

A right channel 40 of the audio circuit is assigned to communicate speaker output 42 that, together with encoded toy-specific audio, produces the interactive effect or background context between a remote interactive toy and a central media player, such as a computer.

In other words, to begin with, the audio desired for output from each remotely located toy is placed entirely on one audio channel. A sub-audible tone relevant to activating a first toy is then placed on an audio content timeline for the duration of that character's speech. The advantage of this is that the decoder in the toy becomes significantly less likely to miss a tone, as it constantly receives input. The result is that when the timeline exceeds the first toy's speech, the CTCSS decoder inside the toy becomes inactive and no more sound comes from the first toy. When the timeline reaches a point where a second toy becomes audibly active, an entirely different sub-audible tone is placed on the timeline for the duration of the second character's speech. The result is that the CTCSS decoder inside the first toy does not recognize the sub-audible tone set for the second toy and therefore remains inactive, whereas the second toy commences operation or remains active for the duration corresponding to the presence of its sub-audible tone or activation code.

As previously indicated, a single toy can also be programmed to respond to several sub-audible tones. For example, a tone of 67 Hz can be assigned to activate the speaker and make the first toy sing, whereas a tone of 71.9 Hz can make the first toy dance for the period the tone is being received, whereas a tone of 74.1 Hz can make the toy dance and sing at the same time. As previously indicated, this process can also be used in combination with other toys. For example, a tone of 67 Hz can make the first toy sing on its own, whereas a tone of 71.9 Hz can make the second toy sing on its own and a tone of 74.1 Hz can make both toys sing together.

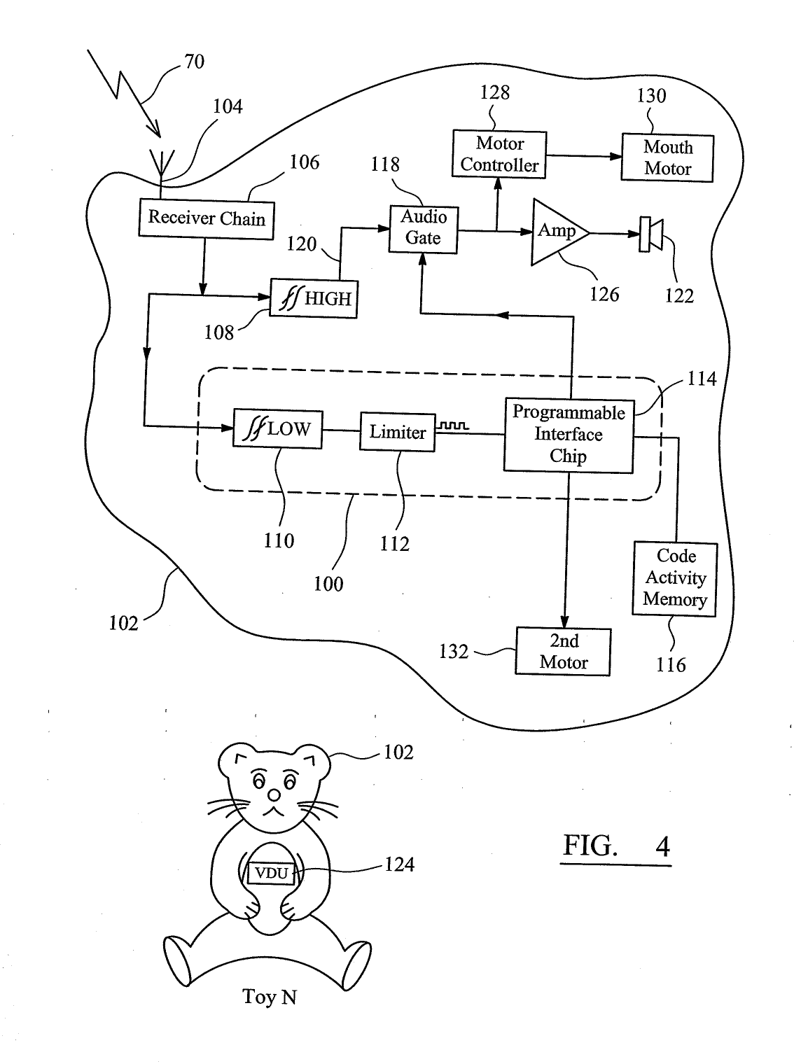

FIG. 3 is a schematic representation of a preferred arrangement for an interactive media suite 50, including an interactive output chain including speakers 51 and a transmitter 53. A media source, such as a DVD or multi-track recording from a television or advertising company, is uploaded from a suitable player or drive 52 into a computer 54 (or equivalent media player). The computer 54, which may be a conventional PC having a dedicated editing program 56, allows a user to deconstruct the entire media package to recover individual channels that are then assigned and encoded with their unique sub-audible tones, as previously explained in relation to FIG. 1 and FIG. 2. The editing program 56 furthermore supports the compilation of the composite signal 32 that defines time synchronization between at least different audio outputs. For a multi-media application containing voice and image content, the editing program 56 also ensures appropriate synchronization between the video and related audio content, as will readily be appreciated.

The computer 54 typically includes at least a sound card 60 that supports the reproduction of stereo audio through at least two speakers 51. Usually, stereo output from the speakers 51 is managed through the use of discrete left and right audio channels, although the present invention makes use of hardware and/or software selectively to cause the right audio channel 40 to be relayed to both stereo speakers 51 to produce a mono effect from directly coupled speakers. Circuitry and software to implement the split of left and right audio channels is well known to the skilled addressee. The left audio channel 33 is routed to the transmitter for modulation and local broadcast. Components in the transmitter 53 are well known to the skilled addressee, although are dependent upon the exact nature of the transmission protocol. In a preferred embodiment, the transmitter makes use of BlueTooth® technology (or the like) to broadcast 70 suitably modulated signals. Preferably, the power in the broadcast is restricted to limit reception to approximately ten metres and preferably less than about five meters.

It will, of course, be understood that wireless transmission is preferred, but not essential. Other forms of communication interface may be used to effect transmission of content from the transmitter to a toy, e.g. a wired connection or optical transmissions.

The computer also preferably includes a video card 62 to allow for visual output that is further synchronised and interactive with the audio (and, if configured, video) output for the remote toys. Video content is therefore provided conventionally either the computer's display, or otherwise via a video output jack. Video frame synchronization with audio content is well known to the skilled addressee, with the additional encoding of sub-audible tone supplementing the general video-to audio synchronization to effectively guarantee the synchronization of at least remote audio to local audio and/or video.

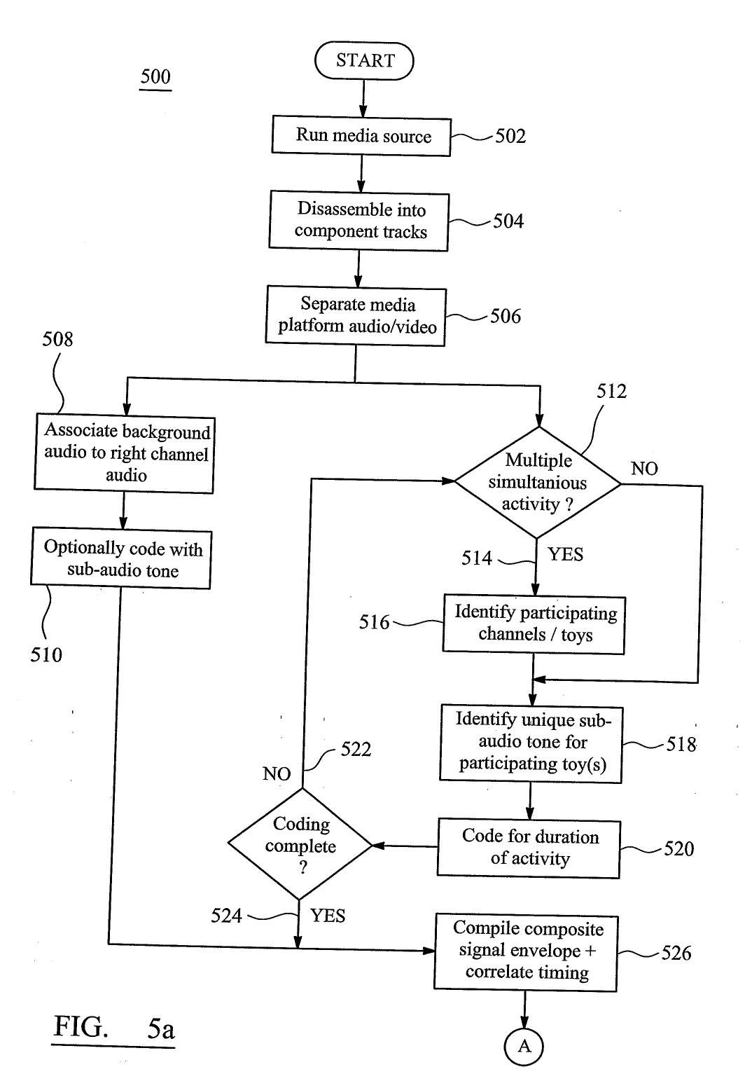

FIG. 4 is a schematic representation of a preferred receiver configuration 100 in a toy 102, the receiver configuration 100 permitting selective recovery and local generation of synchronized output data from the composite signal envelope of FIG. 2.

In FIG. 4, a plurality of toys 102 is shown. Each toy may be a different character and thus subject to a different track and audio content assignable from an original programme or song. For example, a first toy 102 may be produced in the image of the character “Kermit the Frog”, whereas a second toy might be the “Swedish Chef”, with both characters interacting at different points within a video, TV programme or recorded song. The interactive audio content communicated to each toy is therefore tailored to the characters by virtue of the assigned sub-audible tones.

An antenna 104 is coupled to a conventional receiver chain 106. As will be understood, the receiver chain 106 includes (amongst other components) a suitable demodulator, a pre-amplifier and a mixer. An output from the receiver is coupled to both a high pass filter 108 and a low pass filter 110. The low pass filter 110 removes audio content to effect recovery of any sub-audible tone present in the recovered composite signal (emanating from the receiver chain). In response to any signal passed through the low pass filter 110, a limiter 112 operates to provide a discrete transition, i.e. to produce a square wave, which can be applied to and readily assessed by a programmable interface chip (PIC) 114. The PIC 114 (sometimes interchangeably referred to as a microcontroller) therefore operates to identify and decode any sub-audible tone (or other form of coding) mixed with relevant audio content.

In another embodiment, the low pass filter 110, limiter 112 and PIC 114 is instead realised by a digital signal processor (DSP).

The PIC 114 for each toy is provided with a list of sub-audible tones (or embedded signal codes). This list of codes, stored in a memory device 116 or effectively by appropriate hard-wired logic, determines whether the toy is to react to the recovered signals output from the receiver. If the recovered sub-audible tone matches an identified activation tone, an output of the PIC 114 opens an audio gate 118 that is located after an output 120 of the high pass filter 108. The high pass filter 108 is therefore arranged to suppress sub-audible tones and pass audio signals potentially relevant for local regeneration and output from a local speaker 122, whereas the audio gate 118 controls whether these signals are heard from the speaker 122 (or seen if there is a related video display 124 in the toy). Prior to output from the speaker 122, signals are amplified in amplifier 126.

An output from the audio gate may also be tapped and sampled by a motor controller 128 arranged to control a first motor 130. More specifically, motor control can control the instantaneous degree of movement of the motor in response to relative sensed amplitudes in the recovered and relevant audio signal targeted to the specific toy at a specific time.

The PIC 114 may also provide direct control to at least one second motor 132, such as a motor controlling an arm, leg or facial expression, but this is a design option. For example, the PIC may make use of a detected ancillary tone 18 to actuate additional motors in the toy.

In other words, according to a preferred embodiment, each toy includes a CTCSS decoder that is set to respond to a different, specific sub-audible tone in the defined CTCSS frequency range. When the toy is on, the toy's audio receiver constantly receives the audio information transmitted from the audio source. However, unless the CTCSS decoder receives its specific sub-audible tone, it will stop all received audio from reaching the amplifier 126 and motor controller, e.g. an audio sensitive board. The toy will therefore not move and no sound will come from the toy. When the CTCSS decoder receives its specific sub-audible tone, it will allow the received audio to reach the amplifier 126, whereby the toys motors will move and sound content corresponding to the character will be output from the toy's speaker. As soon as the CTCSS decoder, e.g. PIC 114, stops receiving relevant CTCSS tones, sound output and related motor operation is stopped.

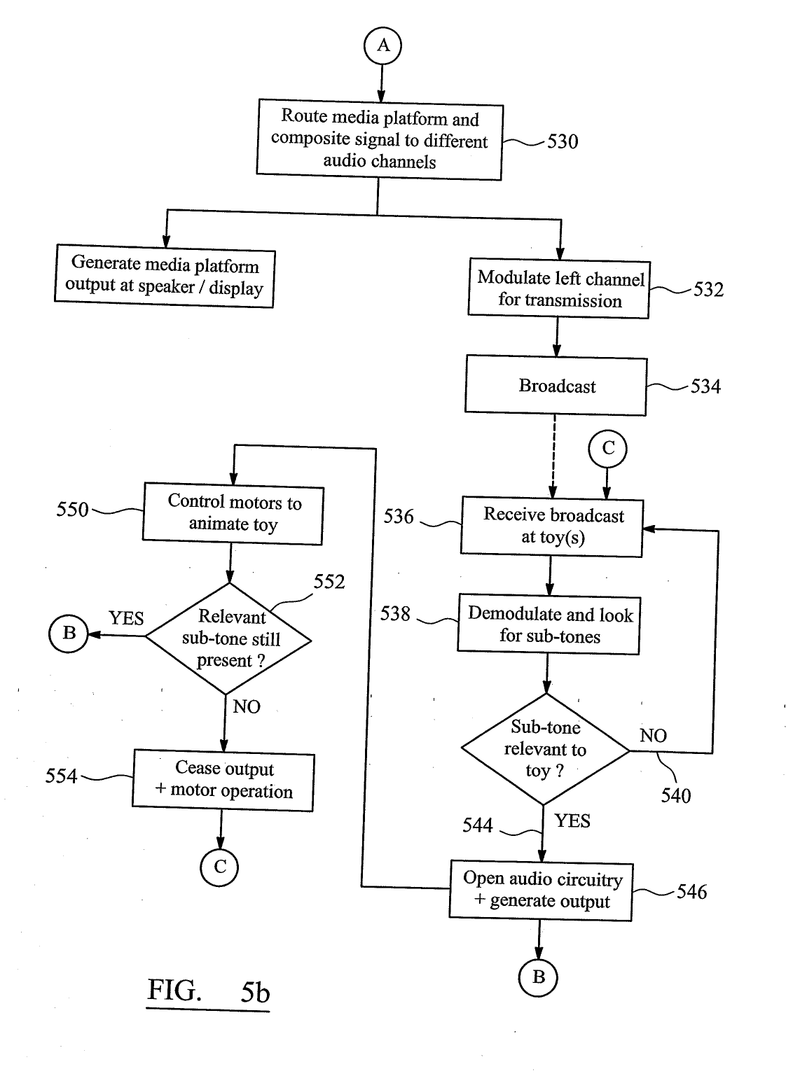

Turning to FIG. 5 (comprised from FIGS. 5a and 5b), a flow diagram of the process 500 for encoding and recovering interactive media according to a preferred embodiment is illustrated.

The process begins 500 with the loading and running 502 of a media content source 502 containing at least multiple audio tracks, but preferably audio tracks and related video content. The media content source 502 is stripped down, i.e. disassembled 504, into component audio tracks that may overlap in time with one another, but may also be distinct in time. At 506, background content (that provides the reference point for at least audio interaction) is separated out, with the background content then assigned 508 to the right audio channel of an audio circuit. Optionally, but preferably, the background audio is coded 510 with a sub-audible tone that uniquely identifies the background content for local use at the computer (or discrete device) of FIG. 3.

An assessment 512 is then made as to whether the remaining audio tracks (for interactive play/output at the remote toys of FIG. 4) contain overlapping activity. In the affirmative 514, the process identifies 516 the participating channels (and thus the participating characters/toys). These channels are encoded 518 with a pre-selected and unique sub-audible tone that, ultimately, will uniquely control operation of at least one animated motor-driven function in each of at least two interactive toys. If there is only one active track (as determined at step 512) for a segment of time/specific duration, then that track is encoded with its own unique and pre-assigned sub-audible tone 18 for the entire time/duration 520. If the coding of the original media content is not complete 522, then the coding regime continues with a return to step 512, otherwise confirmation 524 permits a composite signal envelope (see FIG. 2) to be produced 526, which composite signal envelope includes: i) character audio content; ii) correlated timing (i.e. buffering) between track relative activity/inactivity; and iii) sub-audible coding to uniquely identify the start and cessation of specific interactions and specific character movements.

At 530, the system is configured to effect routing of the media platform (i.e. the background or context) to a first audio channel in an audio circuit, whereas the composite signal is routed to a different audio channel. In this way, the point of reproduction of the background content is separated from the remote point of reproduction of the audio content associated with particular toys.

The composite signal can then be appropriately modulated 532, if necessary, for transmission 534 in the form of broadcast signal 70 (of FIG. 4).

At each of the receivers, i.e. each of the remote toys 104, the receiver chain receives 536 the broadcast and demodulates (if necessary) any received signal and looks for 538 sub-audible tones relevant to its function. If no relevant tone or code is identified, the toy remains in an active search loop 540 but is otherwise dormant (from at least an audio output perspective and typically both an audio and movement perspective). Of course, the toy may be powered down in which case the toy is inactive. If the toy is powered up and a relevant tone is detected (at any point in time) 544, the audio gate is opened and a sound output generated 546 via the toy's speaker.

With a positively identified embedded tone or code, local motors are therefore energized 550 to animate the toy in a controlled fashion reflective of the pre-assigned meaning associated with the embedded code. The rate of operation of the motor or the extent of the operation can be determined locally based on instantaneous variations in the audio content power in the received composite signal, but this is optional and reflects one method of control. The toy, over time, continues to look for and identify 552 relevant embedded codes and will either cease audio output and motor operation 554 or continue both to maintain the audio output open and to effect relevant motor control.

Synchronicity between the left and right audio channels (and therefore the media platform output at the central speaker and the interactive output at the remote speakers) is maintained because of the inherent synchronization and alignment between the left and right audio channels. Processing of the left channel, while taking a finite time, has a negligible effect on synchronization between the remote toys and the central medial player/platform.

The present invention may therefore be embodied in a computer program and supplied on a computer program product, such as a USB memory stick or the like.

The skilled addressee will readily appreciate that the various preferred features described above may be implemented independently of one another or in concert with each other where their co-existence is mutually permissible and complementary in the sense that the overall arrangement of configuration is improved.

It will, of course, be appreciated that the above description has been given by way of example only and that modifications in detail may be made within the scope of the invention. For example, while the preferred embodiment has been described in the context of a cuddly tool and interacting media program, the underlying ideas of using sub-audible tones uniquely assigned to a toy or other inanimate object (or a specific group of toys in the case of a chorus of synchronized responses) can be used in other contexts, including marketing displays in shop windows. The term “toy” should therefore be understood to include “mannequin” or “doll” or, in its broadest sense a device configured to provide a channel output discrete to the background or central output providing a context, script or baseline for a multi-site interaction.

Also, while a preferred embodiment makes use of the left channel audio output for transmission of the composite signal envelope (containing sub-audible code signatures), it will be understood that these could make use of the right audio channel and thus switched with the media platform content. Furthermore, the preferred embodiment is directed towards the synchronization of audio output, although the principle of discrete embedded codes to effect opening of an output gate can be employed in a wider context, e.g. to support interactive video projection at the remote toy, such as cuddly bear in the like.

Also, while a preferred embodiment makes use of CTCSS signals, other coding schemes (such as dual tone multiple frequency, DTMF, or more elaborate in signal coding) can be substituted therefor or augmented therewith. For instance, in more advanced toys having greater numbers of operational features and therefore more motors, DTMF may be preferable and may be supplemental to CTCSS for audio output control. And in combination, DTMF can be sent to the remote toy when CTCSS code is not present, with this meaning that additional information can be sent to the toy without fear of transmission as audio output from the toy's speaker. Supplementary information received in this fashion be locally buffered and used to control or activate another part of the toy.

The term sub-audible tone should be construed more broadly to encompass such alternatives, unless the specific context or embodiment requires otherwise. A high frequency code applied for the duration of the speech burst, for example, could also be used, although this would result in the receiver applying a bandpass filter to isolate the particular code from audio and/or video.

1. A method of supporting an interactive audio experience between a media player and a plurality of remotely located toys, the method comprising:
assigning a context audio track to a first channel to an audio system having two channels;
generating a composite audio signal from a plurality of audio tracks, each audio track associated with a specific one of the plurality of toys, the composite audio signal assigned to a second, different channel of the audio system;
assigning and embedding a unique activation code into each track, the activation code present for substantially an entire duration of activity of each speech segment on each track;
broadcasting the composite audio signal; and
at each of the plurality of toys, detecting the presence of any affiliated activation code within the broadcast signal and opening an audio gate and audio output for the duration of the detection of the affiliated activation code.

2. The method of claim 1, further comprising:
in response to detection of an affiliated activation code, controlling operation of a motor in the toy.

3. The method of claim 1, further comprising:
in response to the presence of overlapping audio on multiple tracks, assigning a unique activation code for the overlapping period for the plurality of toys whose audio overlaps.

4. The method of claim 1, wherein the activation code comprises a sub-audible CTCSS tone.

5. A computer program containing computer code configured to, when run on a computer, implement procedure to execute the steps of claim 1.

6. An interactive toy comprising:
a receiver chain configured to receive a composite audio signal containing multiple audio tracks associated with the operation of multiple different toys, the receiver chain being configured to separate an audio output from embedded activation codes associated with the audio output;
a controller configured to:
detect the presence of a pre-assigned activation code affiliated to the toy; and
open an audio gate for the duration of detection of the pre-assigned activation code, whereby the audio output is reproduced from the toy.

7. The interactive toy of claim 6, further comprising a motor, wherein the controller is configured to control operation of the motor in conjunction with the audio gate, the operation of the motor also dependent upon detection of the pre-assigned activation code.

8. An interactive toy system comprising:
a plurality of interactive, each comprising:
a receiver chain configured to receive a composite audio signal containing multiple audio tracks associated with the operation of multiple different toys, the receiver chain configured to separate an audio output from embedded activation codes associated with the audio output;
a controller configured to:
detect the presence of a pre-assigned activation code affiliated to the toy; and
open an audio gate for the duration of detection of the pre-assigned activation code, whereby the audio output is reproduced from the toy; and
a media player configured to:
assign a context audio track to a first channel of an audio system having two channels;
generate a composite audio signal from a plurality of audio tracks, each audio track associated with a specific one of the plurality of toys, the composite audio signal assigned to a second, different channel of the audio system;
assign and embed a unique activation code into each track, the activation code present for substantially an entire duration of activity of each speech segment on each track; and
a transmitter for broadcasting the composite audio signal, wherein time synchronization exists between the first and second channels of the audio system and time synchronization exists between the context audio track presented by the media player and the audio presented at each of the plurality of interactive toys by virtue of the embedded activation Codes.

9. (canceled)

10. A media player including a transmitter, the media player configured to:
assign a context audio track to a first channel of an audio system having two channels;
generate a composite audio signal from a plurality of audio tracks, each audio track associated with a specific one of the plurality of toys, the composite audio signal assigned to a second, different channel of the audio system;
assign and embed a unique activation code into each track, the activation code present for substantially an entire duration of activity of each speech segment on each track; and wherein
the transmitter is configured to modulate and broadcast the composite audio signal such that time synchronization exists between the first and second channels of the audio system and time synchronization exists between the context audio track presented by the media player and the audio presented at each of the plurality of interactive toys by virtue of the embedded activation codes.

11. The media player according to claim 10, wherein the media player is configured to, in response to the presence of overlapping audio on multiple tracks each associated with individual interactive toys, assign a unique activation code for the overlapping period for interactive toys whose audio overlaps.

12. The media player according to claim 10, wherein the activation code comprises a sub-audible CTCSS tone.
